(19) United States
(12) Patent Application Publication
(10) Pub. No.: US 2002/0082714 A1
(43) Pub. Date: Jun. 27, 2002

(54) Processor control apparatus, processor, and processor controlling method

(76) Inventors: Norichika Kumamoto, Kawasaki (JP); Toru Tsuruta, Kawasaki (JP); Hideki Yoshizawa, Kawasaki (JP)

Correspondence Address: STAAS & HALSEY LLP, 700 11TH STREET, NW, SUITE 500, WASHINGTON, DC, 20001, US

(21) Appl. No.: 09/855,776

(22) Filed: May 16, 2001

(30) Foreign Application Priority Data
Dec. 27, 2000 (JP) 2000-398291

(51) Int. Cl. G05B 15/02

(52) U.S. Cl. 700/1; 700/8; 700/9; 712/229

(57) ABSTRACT

A processor is efficiently controlled and the electric power required to drive the processor is reduced by switching between a process of driving a plurality of arithmetic units using a series of instructions from an instruction control unit and a process of driving a plurality of arithmetic units using a plurality of series of instructions from different instruction control units according to an object to be processed. When a plurality of instruction control units 10, 11 and 12 drive a plurality of arithmetic units 13, 14 and 15, a synchronous execution process of driving the plurality of arithmetic units 13, 14 and 15 using the series of instructions from the first instruction control unit 10 is switched to/from an independent execution process of driving the arithmetic units 13, 14 and 15 using the series of instructions from the instruction control units 10, 11 and 12, respectively, according to the information contained in the series of instructions.

### BACKGROUND OF THE INVENTION

1. Field of the Invention

The present invention relates to a processor control apparatus, a processor, and a processor controlling method for switching between and performing a process of driving a plurality of arithmetic units by a single series of instructions and a process of driving the plurality of arithmetic units by respective series of instructions.

2. Description of the Prior Art

Conventionally, a signal processing system such as an image processing system, a voice processing system, etc., (for example, a portable terminal, a next generation cellular phone), is provided with hardware suitable for processing a signal and hardware suitable for controlling the system. With the progress in device technology, a system is commonly used in which signal processing is carried out by a digital signal processor (DSP) and system control is carried out by a general-purpose microprocessor (MPU). In such a system, a signal can be quickly processed, and system control requiring various interrupt processes can be efficiently provided.

However, since such a system is configured by two different pieces of hardware, there arises a problem that overhead occurs when processes requiring synchronization with each other, for example, image processing including voice processing, are performed. On the other hand, with the recent improvement in the functions of an MPU, a system for realizing all processes including signal processing on an MPU has been introduced. In this system, a signal can be processed and a system can be controlled efficiently, but requires a raise in a clock frequency to improve the function, thereby preventing an apparatus such as a built-in device, etc., in which power has to be saved, from being successfully adopted.

In addition, there is a method used with a parallel process for performing processes at a higher speed without raising a clock frequency. For example, in the VLIW system which is a system for parallelism, an MPU operation and a DSP operation can be performed in parallel by simultaneously performing a plurality of operations through a series of instructions containing a plurality of instructions. However, since a single program counter is used in this system, branch processes such as an interrupt process, a loop process, etc., are simultaneously performed in all operations. Therefore, the effect of parallelism is reduced in the processes containing a number of interrupt processes such as system control and the processes containing a number of loop processes such as signal processing, etc., thereby incurring deterioration in their functions.

### SUMMARY OF THE INVENTION

The present invention has been developed to solve the above-mentioned problems, and aims at providing a processor control apparatus, a processor, and a processor controlling method in which when an MPU and a DSP are to be incorporated in one module for example, the MPU and the DSP can be individually operated independently in the case where tasks are processed less frequently in synchronization with each other, but they can be synchronized in their operations with each other in the case where tasks are processed highly frequently in synchronization with each other, by switching between a process of operating a plurality of arithmetic units by means of a series of instructions from one instruction control unit and a process of operating a plurality of arithmetic units by means of a plurality of instructions from respective different instruction control units, depending on the contents of the processes to be executed.

To solve the above-mentioned problems, according to a first aspect of the present invention, there is provided a processor control apparatus for controlling a plurality of arithmetic units, which comprises a plurality of instruction control units for issuing a series of instructions to the plurality of arithmetic units. Some of the instruction control units are operable to switch between a first execution process for driving the plurality of arithmetic units by means of a single series of instructions and a second execution process for driving the plurality of arithmetic units by means of a plurality of different series of instructions, respectively.

With this configuration, it is possible to efficiently switch between a process including a number of interrupt processes such as a system controlling process, and a process including a number of loop processes such as signal processing. Furthermore, by incorporating such a processor control apparatus in a single processor, a smaller and power-saving processor can be provided as compared with the conventional multiprocessor configuration and the conventional configuration of adding hardware for synchronizing processors.

In a preferred form of the first aspect of the present invention, the some instruction control units each perform a switching process for switching between the first execution process and the second execution process according to information which is contained in advance in a series of instructions.

Thus, by including in advance the information for switching in a series of instructions, instructions can be switched only by the instruction decoder decoding the series of instructions, thereby realizing efficient control with a simple configuration, and requiring no additional hardware resources for switching series of instructions.

In an embodiment of the present invention, a series of instructions contain a switching instruction so that a switching between series of instructions to be executed can be made when the switching instruction is decoded by the instruction decoder. Here, note that a series of instructions comprise a plurality of instructions.

In another preferred form of the first aspect of the present invention, when an M-th one of the instruction control units issues a second series of instructions to an N-th one of the arithmetic units which is performing the second execution process based on a first series of instructions issued by an N-th one of the instruction control units different from the M-th instruction control unit, the M-th instruction control unit is set in a wait state until the N-th arithmetic unit completes the second execution process.

With the above-mentioned configuration, the M-th instruction control unit only has to issue a series of instructions when the N-th arithmetic unit completes the process being performed by the series of instructions from the N-th instruction control unit. Therefore, the next process to be performed can be smoothly started after releasing the wait state without interrupting the process being performed, thereby enhancing the performance. Furthermore, with the above-mentioned configuration, when a plurality of arithmetic units are to be synchronously driven, it is not necessary to store on the M-th instruction control unit side the information as to how many cycles to go at maximum to complete the series of instructions from the N-th instruction control unit. Therefore, the synchronous processes can be efficiently started without interrupting the process being executed.

According to an embodiment of the present invention, when the N-th arithmetic unit is put into a stopped state, a predetermined control signal is output from an instruction decoder for driving the N-th arithmetic unit to the M-th instruction control unit. When the M-th instruction control unit receives the control signal, it is released from the wait state, and issues a series of instructions to the N-th arithmetic unit.

In a further preferred form of the first aspect of the present invention, the processor control apparatus further includes a first storage element for holding a plurality of series of instructions. When an M-th one of the instruction control units issues a second series of instructions to an N-th one of the arithmetic units which is performing the second execution process based on a first series of instructions issued by an N-th one of the instruction control units different from the M-th instruction control unit, the second series of instructions from the M-th instruction control unit are stored in the first storage element. The N-th arithmetic unit executes instructions stored in the first storage element based on information contained in the first series of instructions issued by the N-th instruction control unit.

With the above-mentioned configuration, when an arithmetic unit is executing a first series of instructions, and the instruction being executed is to be interrupted to execute a second series of instructions, the temporarily interrupted first series of instructions can be stored in the predetermined first storage element when the second series of instructions are issued. Therefore, the second series of instructions from another instruction control unit can be issued without a stop, thereby efficiently performing the process. Additionally, since the interrupt process can be performed according to the information contained in a series of instructions, the interrupt process can be efficiently performed without an arithmetic unit excessively interrupting a process being performed.

In a yet further preferred form of the first aspect of the present invention, the processor control apparatus further includes a second storage element which operates to hold, when one of the arithmetic units executing a series of instructions from one of the instruction control units is switched to execute a series of instructions from another instruction control unit, data generated by the series of instructions under execution by associating the data with that instruction control unit which is executing the series of instructions

With the configuration, an intermediate result of the arithmetic operation can be securely stored without saving data in an interrupt process. Therefore, the interrupt process can be quickly performed, and an issued series of instructions can be performed with little latency.

In a still further preferred form of the first aspect of the present invention, it is determined, based on an instruction executing state of each arithmetic unit, one of the arithmetic units to which a new series of instructions is to be issued by one of the instruction control units, and the one instruction control unit is controlled based on the result of the determination so that the new series of instructions are directed to the one arithmetic unit thus determined.

With the above-mentioned configuration, an arithmetic unit from which a series of instructions is to be issued can be determined depending on the status of the hardware, that is, the instruction execution status of the arithmetic unit. Therefore, a plurality of series of instructions can be efficiently switched and issued without incorporating the information about the arithmetic unit to be driven into a series of instructions in advance. Thus, a series of instructions can be made with a simple configuration.

According to a second aspect of the present invention, there is provided a processor control apparatus comprising: a plurality of instruction memories for storing a plurality of series of instructions to be executed by a plurality of arithmetic units; an instruction decoder for decoding a series of instructions from the instruction memories, and outputting a decoded result to any of the plurality of arithmetic units; and a selector for selectively switching between a plurality of series of instructions from the instruction memories to be decoded by the instruction decoder, and supplying a series of instructions thus selected to the instruction decoder.

With the above-mentioned configuration, for example, a synchronous execution process of driving a plurality of arithmetic units using a single series of instructions can be efficiently switched to/from an independent execution process of independently driving arithmetic units using respective series of instructions without synchronization, thereby easily and effectively performing complicated control. With the above-mentioned processor control apparatus incorporated in a single processor, a smaller and more power-saving processor than in the conventional configuration of a plurality of processors and of adding hardware for synchronization between the processors can be provided.

In a preferred form of the second aspect of the present invention, some of the plurality of series of instructions contain information about selective switching between the series of instructions to be performed by the selector, and the instruction decoder decodes the information contained in a series of instructions, and outputs a switching instruction to the selector.

Thus, the switching instruction can be easily output to the selector by incorporating the information about the switching instruction into the series of instructions in advance.

In another preferred form of the second aspect of the present invention, some of the plurality of series of instructions contain a synchronizing instruction for allowing a first predetermined one of the arithmetic units and a second predetermined arithmetic unit to synchronously perform processes. When the synchronizing instruction is issued to the first predetermined arithmetic unit, the first predetermined arithmetic unit is set in a wait state, and an instruction decoder of the second predetermined arithmetic unit does not output a switching instruction to its associated selector if a process is being executed by the second predetermined arithmetic unit upon issuance of the synchronizing instruction, and does not release the wait state of the first predetermined arithmetic unit until the second predetermined arithmetic unit completes the process.

With the above-mentioned configuration, since the first predetermined arithmetic unit to which the synchronizing instruction has been issued is set in a wait state until the second arithmetic unit has completed its process being executed, the process being performed by the second arithmetic unit is not interrupted. After releasing the wait state, the predetermined arithmetic unit can smoothly start the synchronous process, thereby enhancing the performance. Furthermore, since the synchronous process can be performed only by issuing an instruction to a predetermined arithmetic unit, the synchronization can be attained without requiring specific hardware for the synchronization.

In a further preferred form of the second aspect of the present invention, the processor control apparatus further comprises: an instruction queue for temporarily storing, at a stage prior to the selector, a series of instructions to be transmitted from a second one of the instruction memories different from a first one of the instruction memories which stores a series of instructions being executed by the first predetermined arithmetic unit; and a determiner for determining, based on a series of instructions being executed, whether or not the process being performed by the first predetermined arithmetic unit can be interrupted, the determiner operating to output, if the process can be interrupted, an interrupt signal for interrupting the issuance of the series of instructions to the first instruction memory which is a source of the series of instructions being executed, and generate a switching instruction to the selector to switch to a series of instructions from the instruction queue.

With the above-mentioned configuration, it is determined whether or not an interrupt is allowed. If it is allowed, a stored series of instructions is executed from an instruction queue. Therefore, the interrupt can be efficiently performed without excessively interrupting the process being executed. Additionally, by accumulating series of instructions in the instruction queue, the issuance of a series of instructions from the instruction memory is not stopped, thereby efficiently performing the process.

According to a third aspect of the present invention, there is provided a processor control apparatus for controlling a plurality of arithmetic units, the processor control apparatus comprising a plurality of instruction control units for instructing the arithmetic units to execute a series of instructions. Each of the instruction control units includes: an instruction memory for storing a plurality of series of instructions; and an instruction decoder for decoding a series of instructions and supplying the decoded series of instructions to an associated one of the arithmetic units. Some of the instruction control units each have an instruction control selector for selectively switching between a first series of instructions from a first instruction memory of one of the instruction control units and a second series of instructions from a second instruction memory of another instruction control unit different from the one instruction control unit to output one of the first and second series of instructions thus selected to the instruction decoder. Each of the arithmetic units includes: a first register file and a second register file for storing data generated by the first and second series of instructions, respectively, which are supplied from the first and second instruction memories and decoded by an instruction decoder of an associated one of the instruction control units; and an arithmetic unit selector for selectively switching between the data generated by the first and second series of instructions being executed and stored in the first and second register files, respectively, according to an instruction from the associated instruction decoder to supply a selected one of the first and second series of instructions to a calculator.

With the above-mentioned configuration, the issued series of instructions are stored in the register files, and the respective register files are properly switched to be processed, thereby quickly performing an interrupt without saving data for the interrupt with little latency required when series of instructions are switched.

In a preferred form of the third aspect of the present invention, each of the series of instructions includes a VLIW type instruction.

With this configuration, the switching process performed using a series of instructions can be applied to a VLIW type series of instructions. Therefore, the feature of the VLIW processor can be utilized without any change through synchronous operations of arithmetic units. Additionally, when each arithmetic unit is independently driven without synchronization, processes can be performed without disturbance due to an interrupt by a task performed by other arithmetic units, thereby realizing the optimum processing corresponding to the feature of a task which has been hardly performed by the conventional VLIW processor.

In another preferred form of the third aspect of the present invention, each of the series of instructions includes a series of time sharing instructions for serially driving a plurality of ones of the arithmetic units.

With the above-mentioned configuration, since a series of instructions can be issued in time series to each arithmetic unit, a smaller circuit can be used in controlling a processor than in the case where series of instructions are issued in parallel. Especially when there are different numbers of instruction process cycles of arithmetic units, it is possible to suppress an overhead incurred when a plurality of series of instructions are issued in time series.

According to a fourth aspect of the present invention, there is provided a processor control apparatus comprising: a single instruction memory for storing a plurality of series of instructions to be executed by a plurality of arithmetic units; an instruction decoder for decoding a series of instructions from the instruction memory, and outputting a decoded result to any of the plurality of arithmetic units; and a selector for selectively switching between a plurality of series of instructions from the instruction memory to be decoded by the instruction decoder, and supplying a series of instructions thus selected to the instruction decoder, wherein the instruction memory has a plurality of ports for issuing the series of instructions to the respective instruction decoders.

According to a fifth aspect of the present invention, a processor control apparatus for controlling a plurality of arithmetic units, the processor control apparatus comprising a plurality of instruction control units for instructing the arithmetic units to execute a series of instructions. The instruction control units have a single instruction memory used in common for storing a plurality of series of instructions, and each includes an instruction decoder for decoding a series of instructions and supplying the decoded series of instructions to an associated one of the arithmetic units, and the single instruction memory has a plurality of ports for issuing the series of instructions to the respective instruction decoders. Some of the instruction control units each having an instruction control selector for selectively switching between a first series of instructions and a second series of instructions both from the single instruction memory to output one of the first and second series of instructions thus selected to the instruction decoder. Each of the arithmetic units includes: a first register file and a second register file for storing data generated by the first and second series of instructions, respectively, which are supplied from the single instruction memory and decoded by an instruction decoder of an associated one of the instruction control units; and an arithmetic unit selector for selectively switching between the data generated by the first and second series of instructions being executed and stored in the first and second register files, respectively, according to an instruction from the associated instruction decoder to supply a selected one of the first and second series of instructions to a calculator.

With the above-mentioned configurations, since a series of instructions for driving a plurality of arithmetic units can be stored in the same instruction memory, for example, it is not necessary to store one subroutine, etc., in a single program for each arithmetic unit. That is, one common subroutine, etc., can be stored in the single instruction memory, thereby easily managing the program and efficiently using the instruction memory although there are uneven numbers of instructions required in the respective instruction control units. As a result, the required capacity of the instruction memory can be reduced.

In a further preferred form of the present invention, the processor control apparatus further comprises power control elements for controlling power supply to the arithmetic units based on their instruction executing states.

With this configuration, the process of controlling electric power in the entire processor, or the process of controlling electric power independently of each arithmetic unit can be selected as necessary, thereby more flexibly controlling electric power than in the conventional limited power control, and realizing a power-saving processor.

According to a sixth aspect of the present invention, there is provided a processor comprising any one of the above-mentioned processor control apparatuses, and a plurality of arithmetic units driven by the processor control apparatus in a controlled manner.

With such configurations, for example, a synchronous execution in which a plurality of arithmetic units are synchronized using a single series of instructions and an independent execution in which arithmetic units are independently driven by respective series of instructions without synchronization can be efficiently switched. Additionally, since processes can be switched using a simple hardware configuration, a smaller and powersaving processor can be realized.

According to a seventh aspect of the present invention, there is provided a processor controlling method usable with a plurality of instruction control units for controlling a plurality of arithmetic units to execute a plurality of series of instructions, the method comprising the steps of: prescribing, in advance in a series of instructions which is to be performed, synchronous execution in which a plurality of predetermined ones of the arithmetic units are synchronously driven by a single series of instructions, or independent execution in which the plurality of predetermined arithmetic units are independently driven by a plurality of respective series of instructions; and switching between the predetermined arithmetic units for performing a series of instructions based on the contents of the prescription therein.

In the above-mentioned method, since series of instructions to be executed can be switched depending on the contents of the series of instructions by a single processor, a power-saving processor can be efficiently controlled at a low clock frequency.

### DESCRIPTION OF THE DRAWINGS

FIG. 1 is a simple block diagram of the basic configuration of a processor illustrating the operations of program control according to the present invention;

FIG. 2 shows an example of the state of storing a series of instructions in a first instruction memory of a first instruction control unit, and a second instruction memory of a second instruction control unit;

FIG. 3 shows an example of the granularity (size) of a task;

FIG. 4 is a block diagram showing an example of the configuration of a portable terminal using a processor to which the present invention is applied;

FIG. 5 is a block diagram of the basic configuration according to a first embodiment;

FIG. 6 shows an example of a program containing a plurality of series of instructions stored in each instruction memory unit according to the first embodiment;

FIG. 7 is a block diagram of the basic configuration according to a second embodiment;

FIG. 8 shows an example of a program containing a plurality of series of instructions stored in each instruction memory unit according to the second embodiment;

FIG. 9 is a block diagram of the basic configuration according to a third embodiment;

FIG. 10 shows an example of a program containing a plurality of series of instructions stored in each instruction memory unit according to the third embodiment;

FIG. 11 is a block diagram of the basic configuration according to a fourth embodiment;

FIG. 12 shows an example of a program containing a plurality of series of instructions stored in each instruction memory unit according to the fourth embodiment;

FIG. 13 is a block diagram of the basic configuration according to a fifth embodiment;

FIG. 14 is a block diagram of the basic configuration according to a sixth embodiment;

FIG. 15 is a block diagram of the basic configuration according to a seventh embodiment;

FIG. 16 is a block diagram of the basic configuration according to an eighth embodiment;

FIG. 17 shows an example of designing a subroutine in a dual port memory and a single port memory when a program includes the subroutine; and

FIG. 18 is a block diagram of the basic configuration according to a ninth embodiment.

### DESCRIPTION OF THE PREFERRED EMBODIMENTS

Now, preferred embodiments of the present invention will be described below in detail while referring to the accompanying drawings.

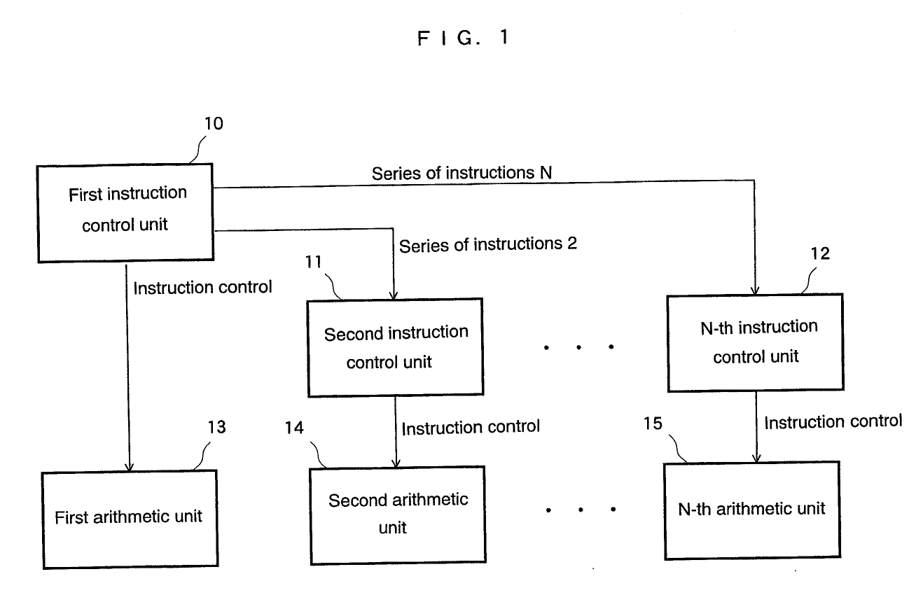

FIG. 1 is a block diagram of the basic configuration of a processor showing the outline of the operations of the program control according to the present invention. The processor comprises a plurality of instruction control units and a plurality of arithmetic units driven under the control of instructions from the instruction control units.

A first arithmetic unit 13 is driven by a series of instructions from a first instruction control unit 10. A second arithmetic unit 14 is driven by a series of instructions from the first instruction control unit 10 or a series of instructions from a second instruction control unit 11. Similarly, an N-th arithmetic unit 15 is operated by a series of instructions from the first instruction control unit 10 or a series of instructions from an N-th instruction control unit 12.

For example, the basic operation of the second arithmetic unit 14 is described below. When the second arithmetic unit 14 is driven by a series of instructions 2 from the first instruction control unit 10, the first arithmetic unit 13 and the second arithmetic unit 14 are driven by the same series of instructions. Therefore, the arithmetic units can be easily synchronized with one another, and data can be correctly transmitted in instruction execution cycle units without a handshake for the synchronization among the units.

On the other hand, when the second arithmetic unit 14 is driven by a series of instructions from the second instruction control unit 11, the second arithmetic unit 14 is driven independently from the first instruction control unit 10 or the first arithmetic unit 13. Therefore, the second arithmetic unit 14 can be continuously operated regardless of an interrupt although there arises a disturbance such as an interruption, etc., to the first instruction control unit 10.

The above-mentioned drive control by the arithmetic units can be performed by switching the series of instructions to be executed in an instruction control unit according to the information contained in the series of instructions, depending on the state of the hardware.

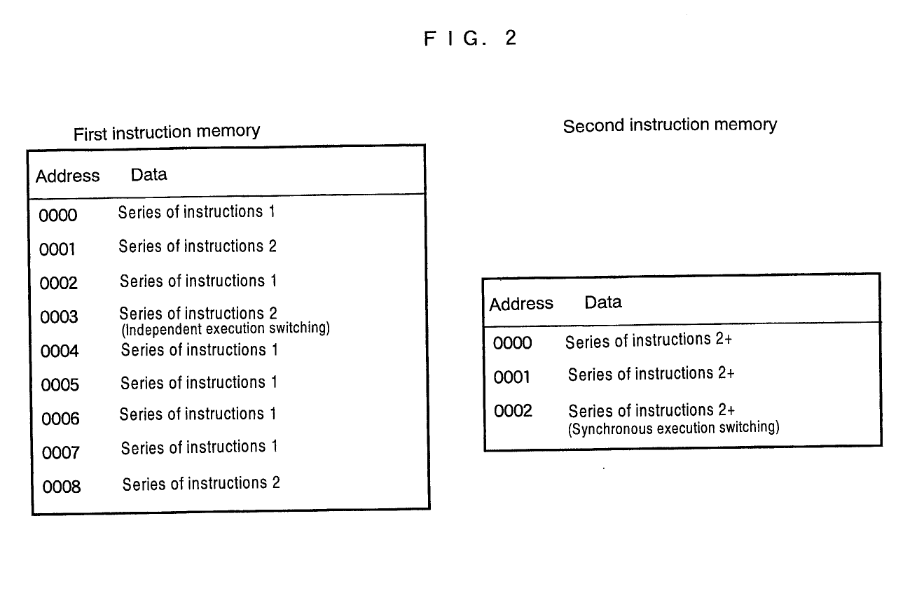

The basic operations in the switching process performed according to the information contained in the series of instructions is briefly described below by referring to FIGS. 1 and 2. In FIG. 1, each instruction control unit includes an instruction memory storing a series of instructions (not shown in the accompanying drawings). FIG. 2 shows the storage state of the series of instructions in the instruction memory, that is, an example of the data structure of the instruction memory. In FIG. 2, the first instruction control unit 10 contains a first instruction memory, and the second instruction control unit 11 contains a second instruction memory.

The first instruction memory stores a series of instructions 1 for driving the first arithmetic unit 13 and a series of instructions 2 for driving the second arithmetic unit 14. Furthermore, the second instruction memory stores only a series of instructions 2+ for driving the second arithmetic unit. First, the second arithmetic unit 14 is driven according to the series of instructions 2 at the address 0001 in the first instruction memory in synchronization with the first arithmetic unit driven according to the series of instructions 1. Furthermore, at the address 0003, the series of instructions 2 stored at the address is similarly executed. The series of instructions 2 contains an independent execution switching instruction, and the second instruction control unit 11 decodes the switching instruction, and then switches a series of instructions to be executed from the series of instructions 2 issued from the first instruction memory to the series of instructions 2+ issued from the second instruction memory.

When the series of instructions is switched, the second arithmetic unit 14 independently executes the series of instructions 2+ stored in the second instruction memory. During the process, the first arithmetic unit 13 also independently executes the series of instructions 1 from the address 0004 to the address 0006 of the first instruction memory. Although the second arithmetic unit 14 independently executes the series of instructions up to the address 0002 of the second instruction memory, the series of instructions 2+ stored at the address 0002 contains a “synchronous execution switching” instruction. When the second instruction control unit 11 decodes the switching instruction, it switches the series of instructions to be executed to the series of instructions 2 issued from the first instruction memory. The second arithmetic unit 14 is driven by the series of instructions 2 stored at the address 0008 of the first instruction memory in synchronization with the first arithmetic unit 13 driven by the series of instructions 1.

The synchronous execution and the independent execution are normally switched depending on the granularity (size) of a task which is a unit of a process. When a task is fine-grained (small-sized), a synchronous process is normally significant. When a task is coarse-grained (large-sized), an independent process is normally desired. Therefore, when a task is fine-grained, each arithmetic unit is driven by an instruction from the same instruction control unit to flexibly perform a synchronous process among arithmetic units. When a task is coarse-grained, arithmetic units are driven by respective instruction control units to operate the arithmetic units regardless of the disturbance such as an interruption, etc.

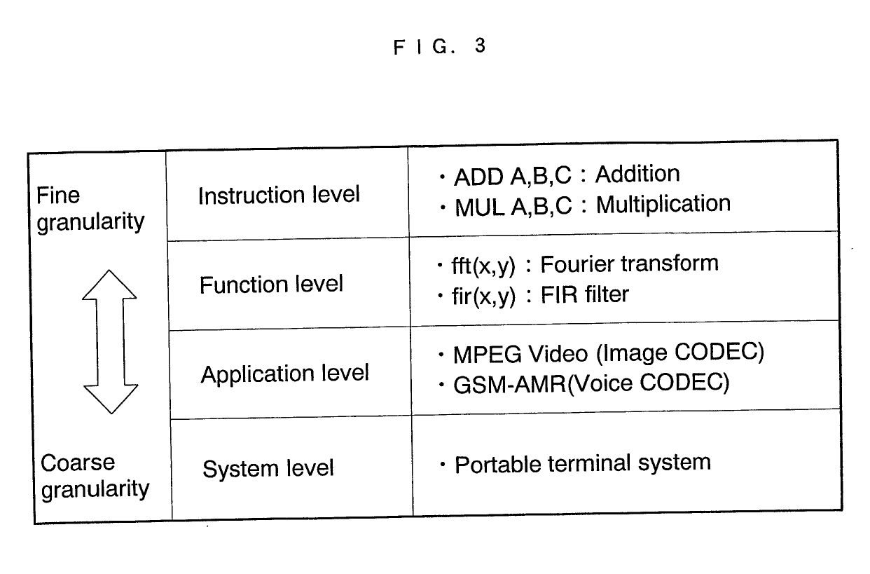

The switch by the above-mentioned series of instructions can be realized by incorporating the specification of independent execution or synchronous execution into a series of instructions in advance depending on the granularity (size) of a task to be executed. FIG. 3 shows an example of the granularity of a task. It is determined whether a process is performed by synchronous execution or independent execution depending on the restrictions based on the difficulty of control, a process time, etc., in addition to the granularity. Although a task is coarse-grained, it may be convenient to perform synchronous execution if overhead can be reduced, and the determination is not limited to the example shown in FIG. 3.

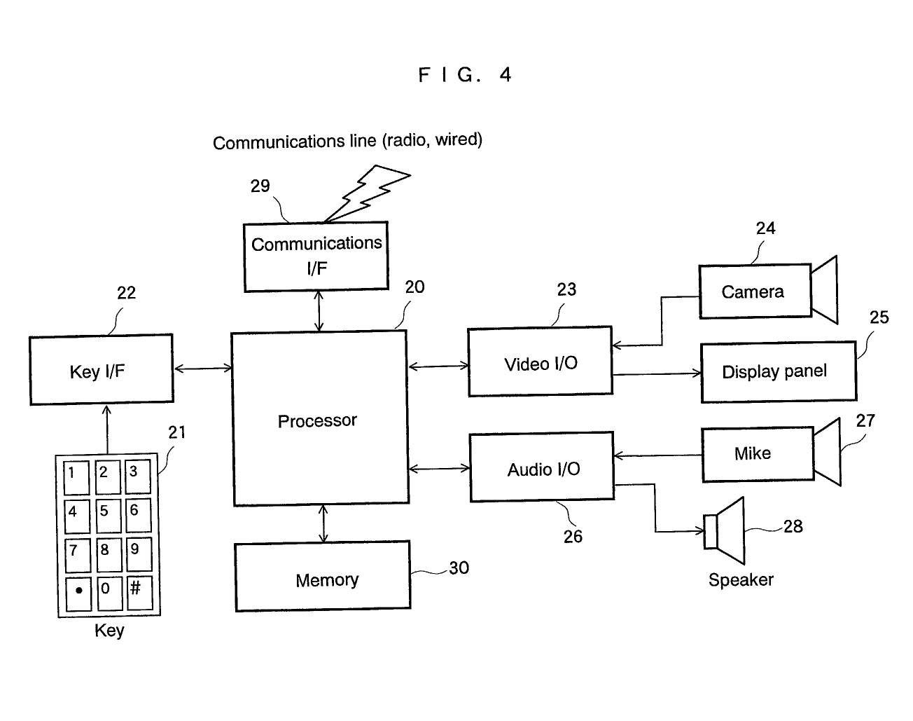

FIG. 4 shows an example of the configuration of a portable terminal using a processor to which the present invention is applied. A processor 20 receives an input of a key 21 through a key I/F 22, receives an image from a camera 24 through a video I/O 23, displays an image on a display panel 25, receives voice from a mike (microphone) 27 through an audio I/O 26, and outputs voice to a speaker 28. The obtained data can be stored in a memory 30 and transmitted to and received from an external device through a communications I/F 29. Furthermore, the processor 20 performs a synchronous process as necessary. According to the present invention, a synchronous process and independent execution can be efficiently switched to and from each other, and the present invention can be applied to a device such as a portable terminal which requires a small, high-performance, and power-saving processor.

Various embodiments of the present invention will be described below in detail by referring to the accompanying drawings.

Embodiment 1

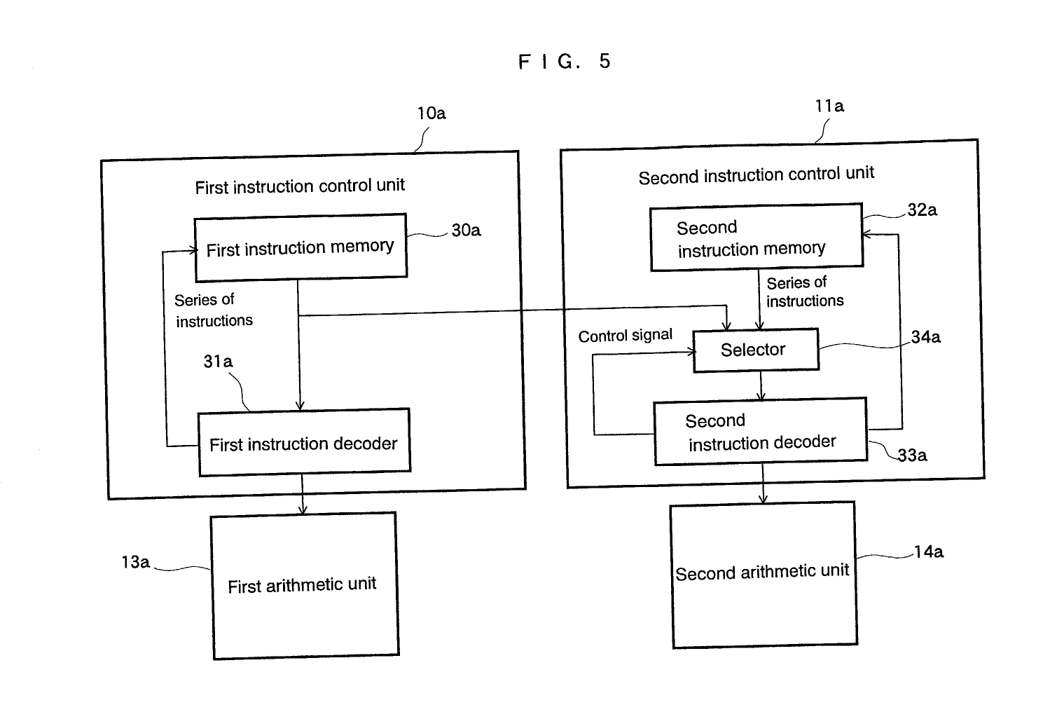

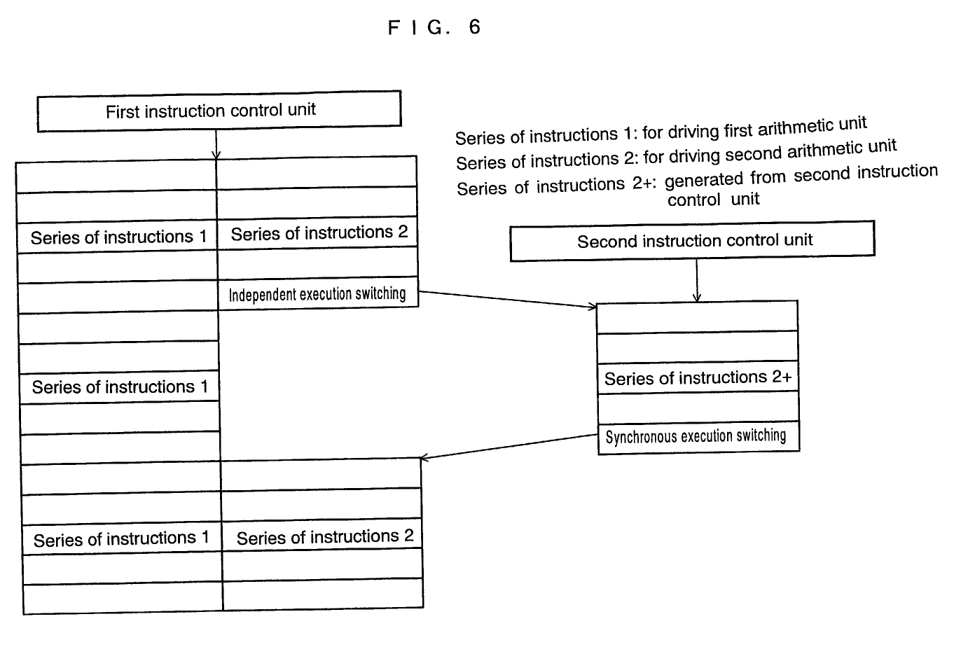

FIG. 5 is a block diagram showing an example of a processor configured by two arithmetic units and two instruction control units. FIG. 6 shows an example of a program containing a plurality of series of instructions stored in a first instruction memory 30a and a second instruction memory 32a shown in FIG. 5.

In FIG. 5, the first instruction control unit 10a comprises the first instruction memory 30a storing a series of instructions for driving the first arithmetic unit 13a and the second arithmetic unit 14a, and a first instruction decoder 31a for decoding a series of instructions from the first instruction memory 30a, and outputting it to the first arithmetic unit 13a. The second instruction control unit 11a comprises the second instruction memory 32a storing a series of instructions for driving the second arithmetic unit 14a, a second instruction decoder 33a for decoding a series of instructions from the first instruction memory 30a and the second instruction memory 32a, and outputting the result to the second arithmetic unit 14a, and a selector 34a for switching a series of instructions from any of the first instruction memory 30a and the second instruction memory 32a and supplying the result to the second instruction decoder 33a.

In the example of a program shown in FIG. 6, the series of instructions 1 drives the first arithmetic unit 13a, and the series of instructions 2 drives the second arithmetic unit 14a. First, the series of instructions 1 and the series of instructions 2 issued from the first instruction control unit 10a synchronously drive the first arithmetic unit 13a and the second arithmetic unit 14a. At this time, the selector 34a provides the series of instructions 2 from the first instruction memory 30a to the second instruction decoder 33a.

When the second instruction decoder 33a decodes an independent execution switching instruction of the series of instructions 2, the second instruction decoder 33a outputs a control signal to the selector 34a. Upon receipt of the control signal, the selector 34a switches such that a series of instructions from the second instruction memory 32a can be provided for the second instruction decoder 33a. Simultaneously, the second instruction decoder 33a instructs the second instruction memory 32a to issue a series of instructions. At this time, the synchronous execution process terminates, and is switched to the independent execution process for independently driving and operating each arithmetic unit.

In the independent execution process, the second arithmetic unit 14a executes the series of instructions 2+ issued from the second instruction memory 32a of the second instruction control unit 11a. During the process, the first arithmetic unit 13a also executes the series of instructions 1 issued from the first instruction memory 30a. When the second instruction decoder 33a decodes a “synchronous execution switching” instruction after the process of the series of instructions 2+ has been completed, a control signal is output from the second instruction decoder 33a to the selector 34a. Upon receipt of the control signal, the selector 34a switches such that the series of instructions from the first instruction memory 30a can be provided for the second instruction decoder 33a. Simultaneously, the second instruction decoder 33a instructs the second instruction memory 32a to stop issuing a series of instructions. At this time, the independent execution process terminates and is switched to the synchronous execution process in which each arithmetic unit is synchronously driven and operated.

Thus, a series of instructions contains a switching instruction in advance, and the instruction switches the independent execution process and the synchronous execution process. According to the embodiment of the present invention, in the independent execution process performed by the second arithmetic unit 13a using the series of instructions 2+ , it is determined in advance how many cycles at maximum to go to terminate the process. The series of instructions 1 and 2 issued from the first instruction memory 30a to synchronously drive the arithmetic units are automatically issued to each instruction decoder based on the determination. Therefore, according to the present embodiment, when a synchronous execution switching instruction is decoded, the second instruction decoder 33a does not instruct the first instruction memory 30a to issue an instruction.

Embodiment 2

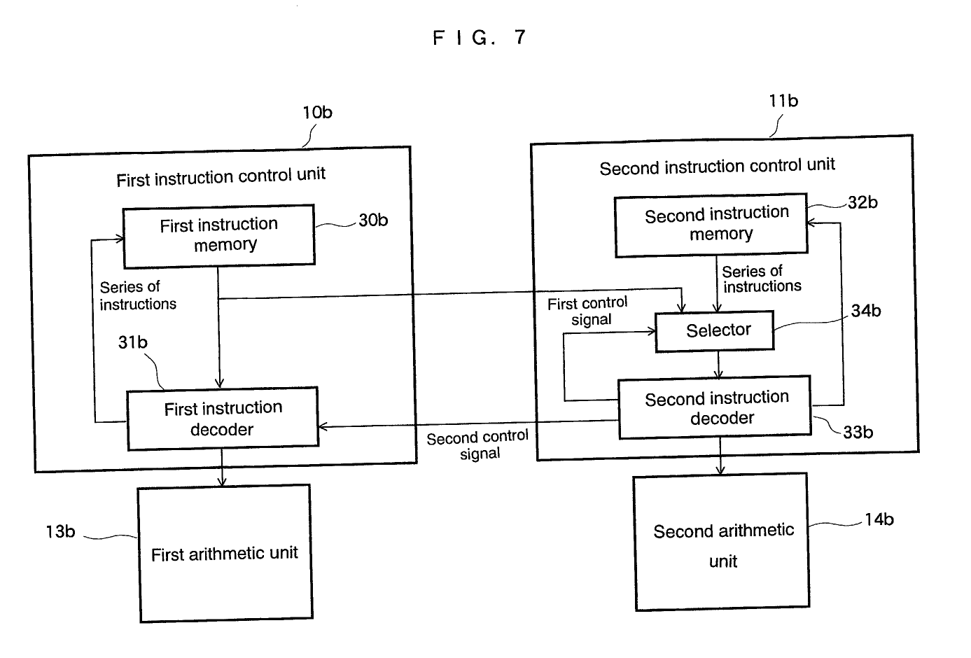

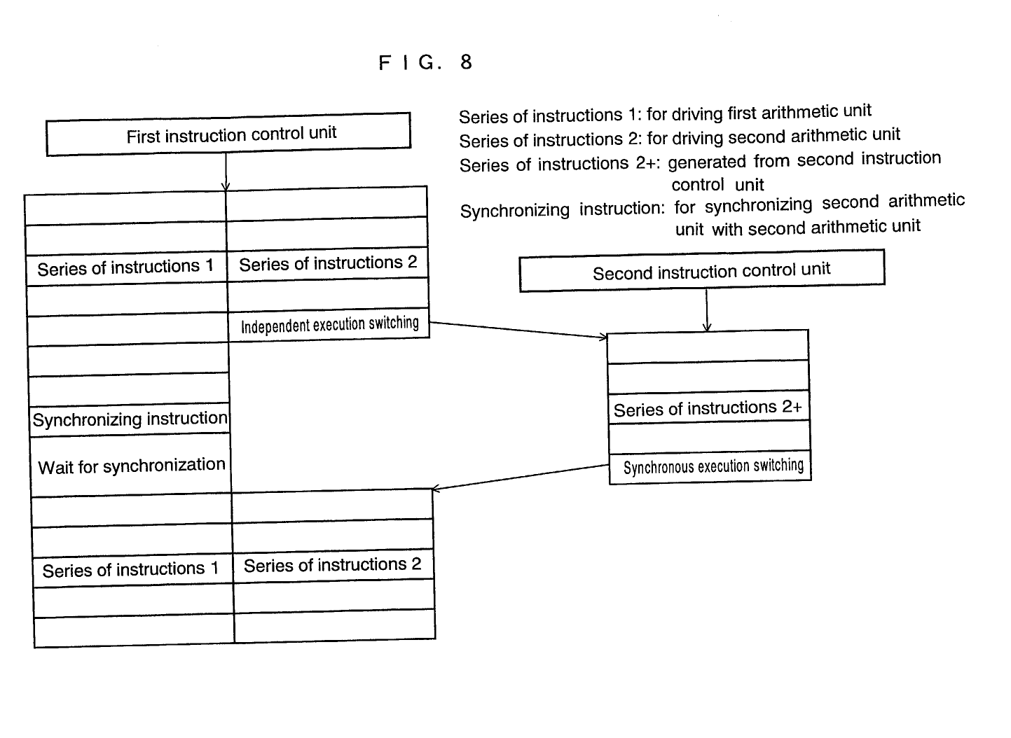

FIG. 7 is a block diagram showing an example of a processor configured by two arithmetic units and two instruction control units. The operation is different from the operation according to the embodiment 1. That is, according to the present embodiment, the first instruction control unit 10b and the first arithmetic unit 13b are temporarily set in a wait state to perform a synchronous execution process. FIG. 8 shows an example of a program containing a plurality of series of instructions stored in the first instruction memory 30b and the second instruction memory 32b shown in FIG. 7.

First, before starting the independent execution process by the “independent execution switching” instruction of the series of instructions 2, the embodiment 2 is the same as the above-mentioned embodiment 1. According to the present embodiment, when the first instruction control unit 10b instructs the second arithmetic unit 14b which is performing an independent execution process to perform a synchronous execution process, the first instruction memory 30b issues to the first instruction decoder 31b a “synchronizing instruction” to set the first instruction control unit 10b and the first arithmetic unit 13b in a wait state until the independent execution process of the second arithmetic unit 14b terminates.

When the first instruction decoder 31b decodes the “synchronizing instruction”, the first instruction decoder 31b instructs the first instruction memory 30b to stop issuing a series of instructions, and sets it in a wait state until the second arithmetic unit 14b terminates the independent execution. When the second arithmetic unit 14b which is performing independent execution completes its process and the second instruction memory 32b of the second instruction control unit 11b decodes a “synchronous execution switching” instruction in the series of instructions 2+, the second instruction decoder 33b outputs a first control signal to the selector 34b. Upon receipt of the first control signal, the selector 34b switches to the series of instructions from the first instruction memory 30b to be provided for the second instruction decoder 33b. The second instruction decoder 33b instructs the second instruction memory 32b to stop issuing a series of instructions. Simultaneously, the second instruction decoder 33b issues the second control signal to the first instruction decoder 31b of the first instruction control unit 10b. Upon receipt of the second control signal, the first instruction decoder 31b releases the wait state of the first instruction memory 30b, and instructs it to issue a series of instructions. At this time, the independent execution process terminates, and is switched into the synchronous execution process in which arithmetic units can be synchronously driven.

Thus, according to the present embodiment, the second control signal is necessarily issued to the first instruction decoder 31b as a termination signal when the independent execution of the second arithmetic unit 14b terminates. Therefore, the synchronous execution process can be started without fail although it is not determined how many cycles at maximum to go to terminate the independent execution process comprising the series of instructions 2+ to be executed by the second arithmetic unit 14b.

Embodiment 3

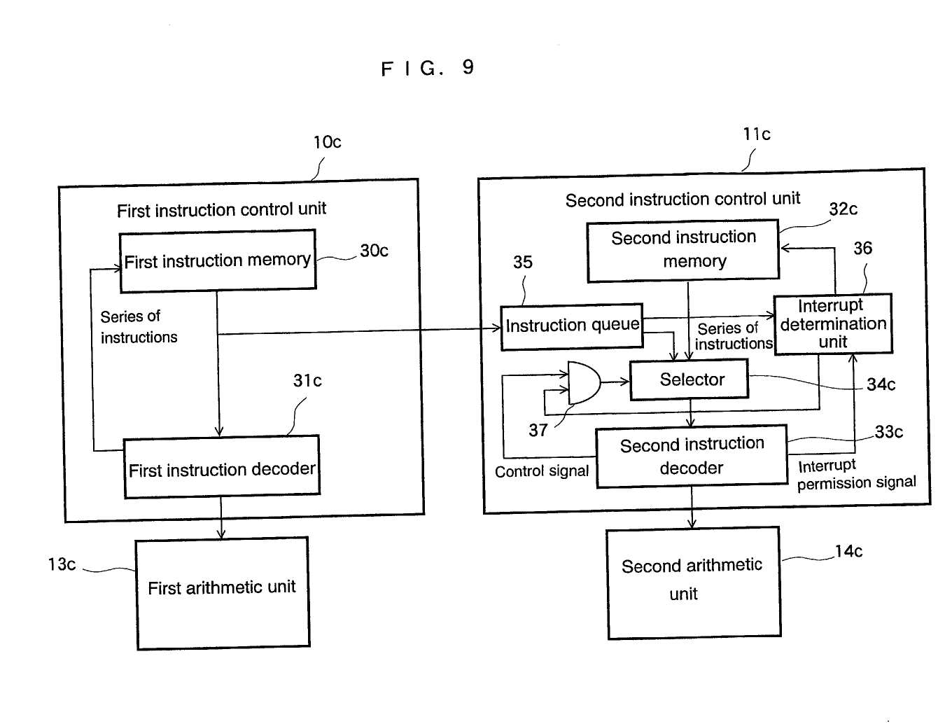

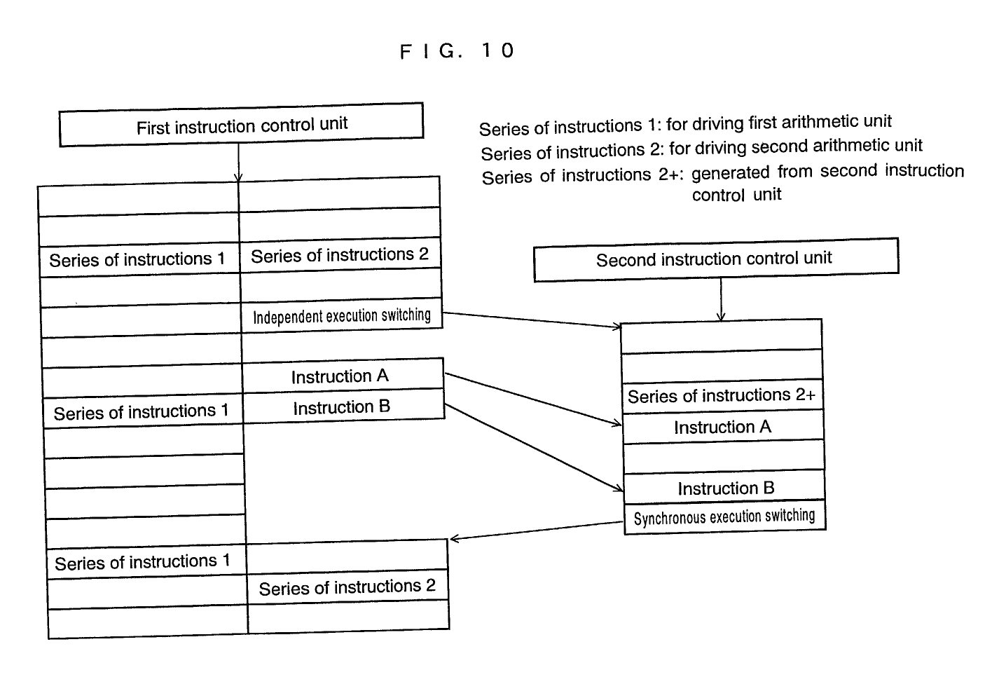

FIG. 9 shows a block diagram showing an example of a processor comprising two arithmetic units and two instruction control units. In addition to the configuration of the above-mentioned embodiment 1, the second instruction control unit 11c comprises an instruction queue 35 for temporarily storing series of instructions, an interrupt determination unit 36 for determining whether or not an interrupt can be performed during the execution of a series of instructions, and an AND circuit 37 for obtaining a logical product of the control signal output from the second instruction decoder 33c and the control signal output from the interrupt determination unit 36. The selector 34c switches depending on the output of the AND circuit 37 so that an interrupt can be performed from the first instruction control unit 10c during the independent execution process of the second arithmetic unit 14c. FIG. 10 shows an example of a program containing a plurality of instructions stored in the first instruction memory 30c and the second instruction memory 32c of the processor shown in FIG. 9.

The process is the same as in the above-mentioned embodiment 1 until the independent execution process to be performed by the “independent execution switching” instruction of the series of instructions 2 is started. According to the present embodiment, when the first instruction control unit 10c issues a series of instructions (instructions A and B shown in FIG. 10) to the second arithmetic unit 14c which is performing an independent execution process, the issued series of instructions is temporarily stored in the instruction queue 35.

The series of instructions 2+ issued from the second instruction memory 32c contains the information as to whether or not an interrupt can be accepted during the execution of a series of instructions. If it can be accepted, and when the information is decoded by the second instruction decoder 33c, the second instruction decoder 33c outputs an interrupt permission signal to the interrupt determination unit 36. Simultaneously, a control signal is output to the AND circuit 37. On the other hand, when an instruction A from the first instruction control unit 10c is stored in the instruction queue 35, the instruction queue 35 notifies the interrupt determination unit 36 that a series of instructions to be processed in the interrupt process has been stored. Upon receipt of both notification and interrupt permission signal, the interrupt determination unit 36 outputs an interrupt determination signal to the AND circuit 37, and simultaneously instructs the second instruction memory to temporarily stop issuing a series of instructions.

The AND circuit 37 obtains, for example, a logical product of an interrupt determination signal and a control signal, and switches the selector 34c to the instruction queue 35 only when it receives both signals. The switched selector 34c provides the instruction A stored by the second arithmetic unit 14c in the instruction queue 35 for the second instruction decoder 33c. When the execution of the instruction A is completed, the second instruction decoder 33c outputs a control signal to the AND circuit 37. To resume the suspended independent execution process, the selector 34c switches such that the series of instructions issued from the second instruction memory 32c can be executed by the second arithmetic unit 14c.

The instruction B as well as the above-mentioned instruction A also can be executed by interrupting the independent execution of the second arithmetic unit 14c. It is obvious that an interrupt is not accepted depending on the contents of the process performed by the series of instructions 2+ of the independent execution. In this case, the instruction waits for the completion of the execution of the series of instructions 2+.

Embodiment 4

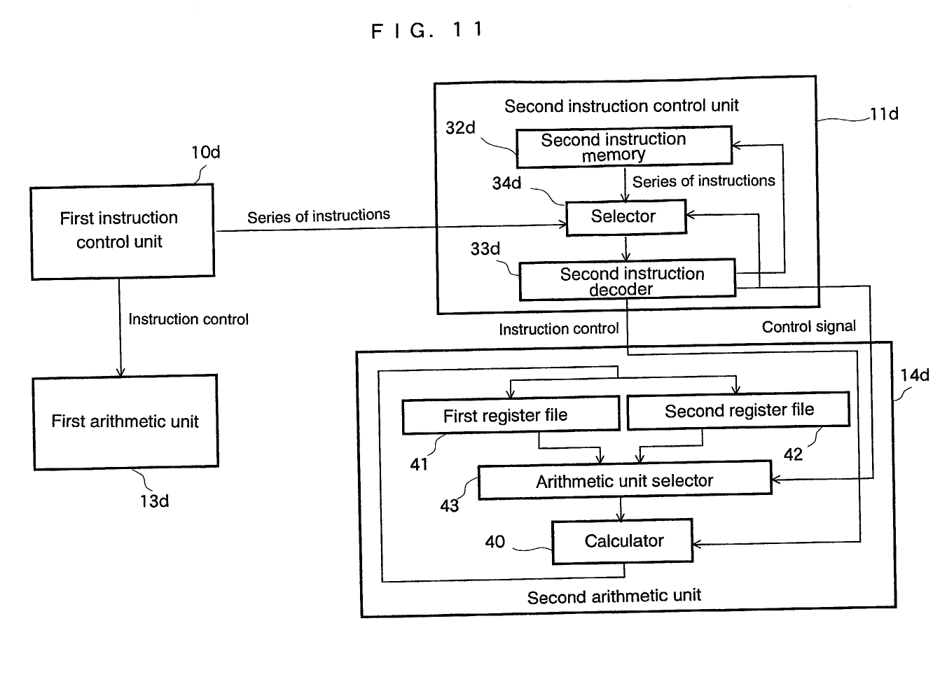

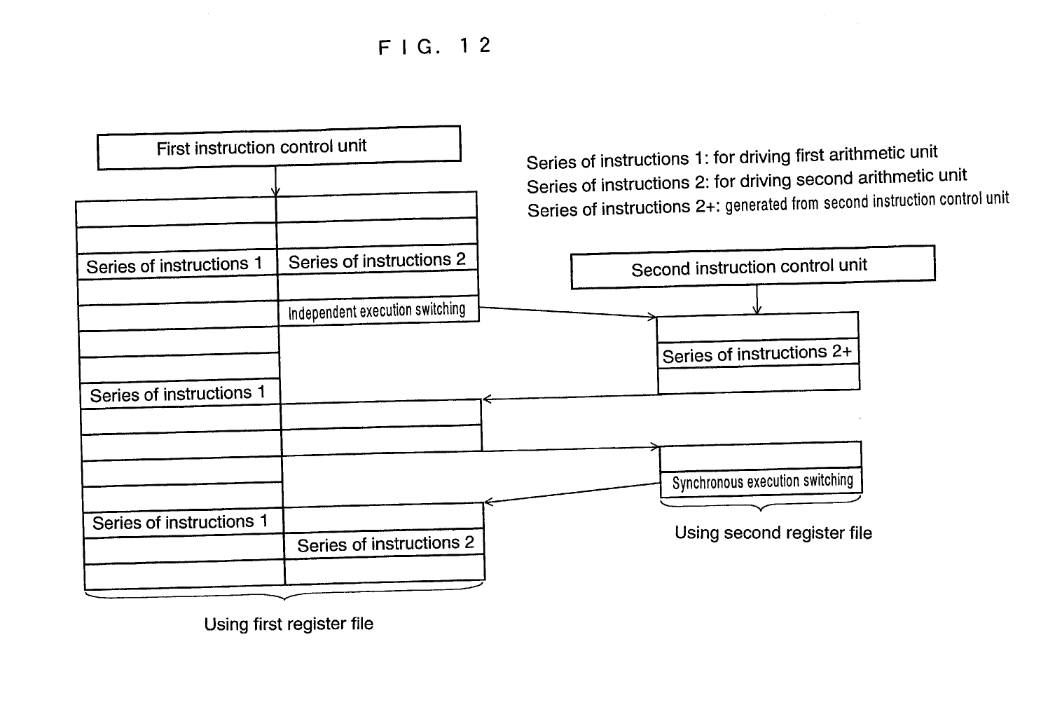

FIG. 10 shows a block diagram showing an example of a processor comprising two arithmetic units and two instruction control units. In addition to the configuration according to the above-mentioned embodiment 1, the second arithmetic unit 14d comprises: a calculator 40 for performing an arithmetic operation; a first register file 41 for storing data (result of an arithmetic operation) generated by executing a series of instructions from the first instruction control unit 10d; a second register file 42 for storing data generated by executing a series of instructions from the second instruction control unit 11d; and an arithmetic unit selector 43 for switching data stored in either first register file 41 or second register file 42 according to an instruction from the second instruction decoder 33d, and providing the data for the calculator 40. For example, during the independent execution process of the second arithmetic unit 14d, an interrupt from the first instruction control unit 10d can be performed. FIG. 12 shows an example of a program containing a plurality of series of instructions stored in the first instruction memory (not shown in the drawings) and the second instruction memory 32d of the first instruction control unit 10d oft he processor shown in FIG. 11.

According to the present embodiment, the data generated when a series of instructions issued from the first instruction control unit 10d to the second arithmetic unit 14d is stored in the first register file 41 when the series of instructions to be executed by the second arithmetic unit 14d is switched into the series of instructions from the second instruction control unit 11d during the execution of the series of instructions. In addition, the data generated when the series of instructions issued from the second instruction control unit 11d to the second arithmetic unit 14d is executed is stored in the second register file 42 when the series of instructions to be executed by the second arithmetic unit 14d is switched into the series of instructions from the first instruction control unit 10d during the execution of the series of instructions.

The operations according to the present embodiment are described in detail by referring to FIG. 12. First, the series of instructions 1 and 2 of the first instruction control unit 10d synchronously drive the first arithmetic unit 13d and the second arithmetic unit 14d. At this time, the selector 34d provides the series of instructions 2 from the first instruction control unit 10d for the second instruction decoder 33d, and the arithmetic unit selector 43 provides the data stored in the first register file 41 for the calculator 40.

When the synchronous execution is completed, and the second instruction decoder 33d decodes the “independent execution switching” instruction in the series of instructions 2, the second instruction decoder 33d instructs the second instruction memory 32d to issue a series of instructions. Simultaneously, a control signal is output from the second instruction decoder 33d to the selector 34d and the arithmetic unit selector 43. Upon receipt of the control signal, the selector 34d switches such that the series of instructions from the second instruction memory 32d can be provided for the second instruction decoder 33d. Upon receipt of the control signal, the arithmetic unit selector 43 switches such that the data stored in the second register file 42 can be provided for the calculator 40. At this time, the second arithmetic unit 14d starts executing the series of instructions 2+ for performing an independent execution process.

When the first instruction control unit 10d issues a series of instructions to the second arithmetic unit 14d during the execution of the series of instructions 2+, the selector 34d automatically switches such that the series of instructions from the first instruction control unit 10d is provided for the second instruction decoder 33d. Simultaneously, the arithmetic unit selector 43 switches such that the data stored in the first register file 41 can be provided for the calculator 40. At this time, the data obtained during the arithmetic operation by the series of instructions from the second instruction control unit 11d is stored in the second register file 42. Furthermore, the second instruction decoder 33d instructs the second instruction memory 32d to stop issuing a series of instructions. At this time, the calculator 40 starts executing the series of instructions from the first instruction control unit 10d.

When the interrupt process from the first instruction control unit 10d is completed, the second instruction decoder 33d instructs the second instruction memory 32d to resume issuing a series of instructions. The selector 34d automatically switches such that the series of instructions from the second instruction memory 32d can be provided for the second instruction decoder 33d. Simultaneously, the arithmetic unit selector 43 switches such that the data stored in the second register file 42 can be provided for the calculator 40, and the suspended series of instructions 2+ can be resumed. In this case, the data obtained during the arithmetic operation by the series of instructions from the second instruction control unit 11d is stored in the second register file 42. Therefore, using the data, the suspended process can be resumed. Thus, an interrupt process can be performed at a high speed without saving data for the interruption.

Embodiment 5

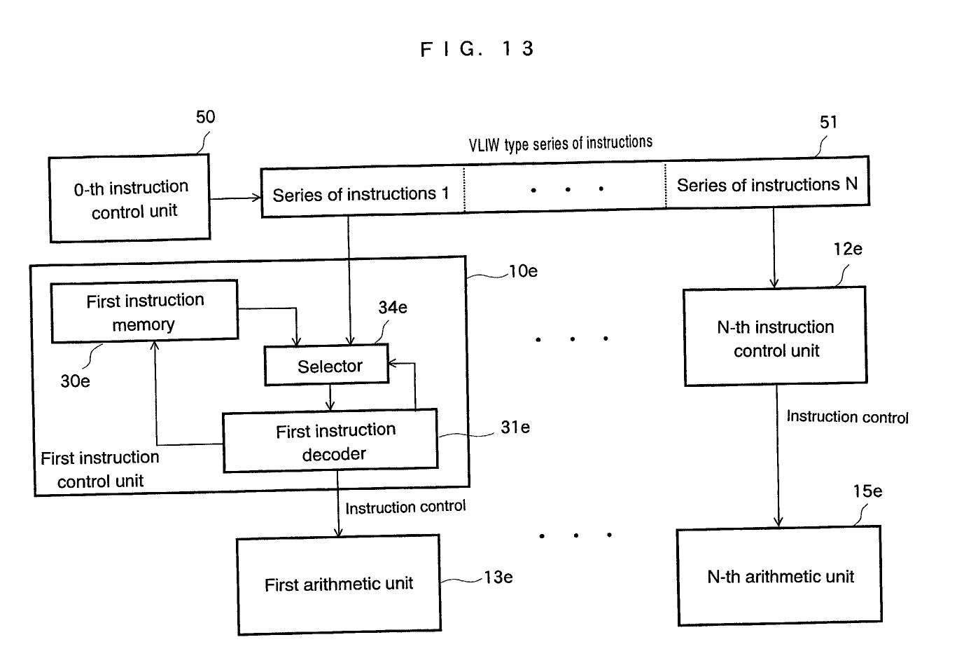

FIG. 13 is a block diagram showing an example of a processor comprising a primary instruction control unit (a 0-th instruction control unit 50 according to the present embodiment), a plurality of secondary instruction control units (the first instruction control unit 10e to the N-th instruction control unit 12e), and a plurality of arithmetic units (the first arithmetic unit 13e to the N-th arithmetic unit 15e) corresponding to the secondary instruction control units. The present embodiment has a configuration in which a VLIW type series of instructions 51 is issued from the 0-th instruction control unit 50 to each secondary instruction control unit, and the arithmetic units are synchronously driven as shown in FIG. 13.

When the series of instructions 1 in the VLIW type series of instructions from the 0-th instruction control unit 50 is issued to the first instruction control unit 10e, the selector 34e of the first instruction control unit 10e switches such that the series of instructions 1 can be provided for the first instruction decoder 31e as in the above-mentioned embodiment 1. The first arithmetic unit 13e executes the series of instructions 1 decoded by the first instruction decoder 31e. Other secondary instruction control units perform similar operations to execute the VLIW type series of instructions from the 0-th instruction control unit 50. Thus, by driving each arithmetic unit by the VLIW type series of instructions of the 0-th instruction control unit 50, the feature of the VLIW type series of instructions can be utilized as is in performing a synchronous execution process, and an independent execution process can be performed based on the series of instructions from each instruction memory for each secondary instruction control unit, thereby performing various processes depending on the granularity (size) of a task.

Embodiment 6

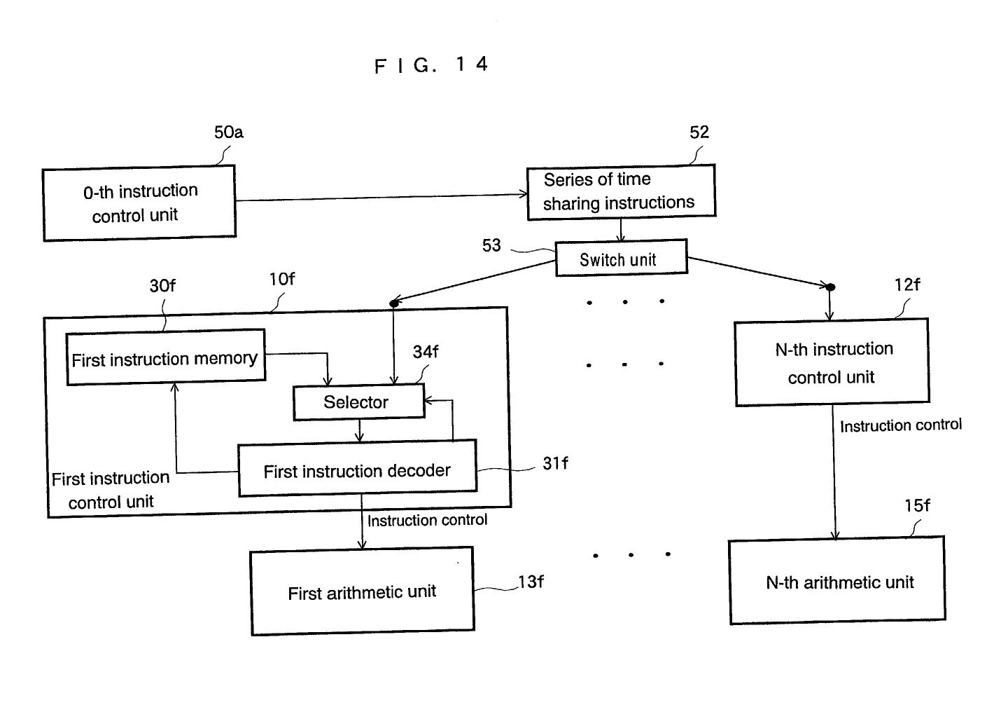

FIG. 14 is a block diagram showing an example of a processor comprising a primary instruction control unit (a 0-th instruction control unit 50a according to the present embodiment), a plurality of secondary instruction control units (the first instruction control unit 10f to the N-th instruction control unit 12f), a plurality of arithmetic units (the first arithmetic unit 13f to the N-th arithmetic unit 15f) corresponding to the secondary instruction control units, and a switch unit 53 for allotting a series of time sharing instructions 52 from the 0-th instruction control unit 50a to each secondary instruction control unit.

According to the present embodiment, the information as to which arithmetic unit drives each series of instructions of the series of time sharing instructions 52 is incorporated into the series of time sharing instructions 52 from the 0-th instruction control unit 50a. According to the information, the switch unit 53 issues a series of instructions in a time sharing manner (serially) to each instruction control unit. For example, if a series of instructions is to be issued to the first instruction control unit 10f, the switch unit 53 switches such that a series of instructions can be issued to the first instruction control unit 10f. Upon receipt of the issued series of instructions, the first instruction control unit 10f switches the selector 34f, the first instruction decoder 31f decodes the series of instructions, and the first arithmetic unit 13f starts executing the series of instructions decoded by the first arithmetic unit 13f. When the series of time sharing instructions 52 issues a series of instructions, other instruction control units execute the process in a similar operation. Thus, arithmetic units are driven and operated in parallel by the series of time sharing instructions 52.

Embodiment 7

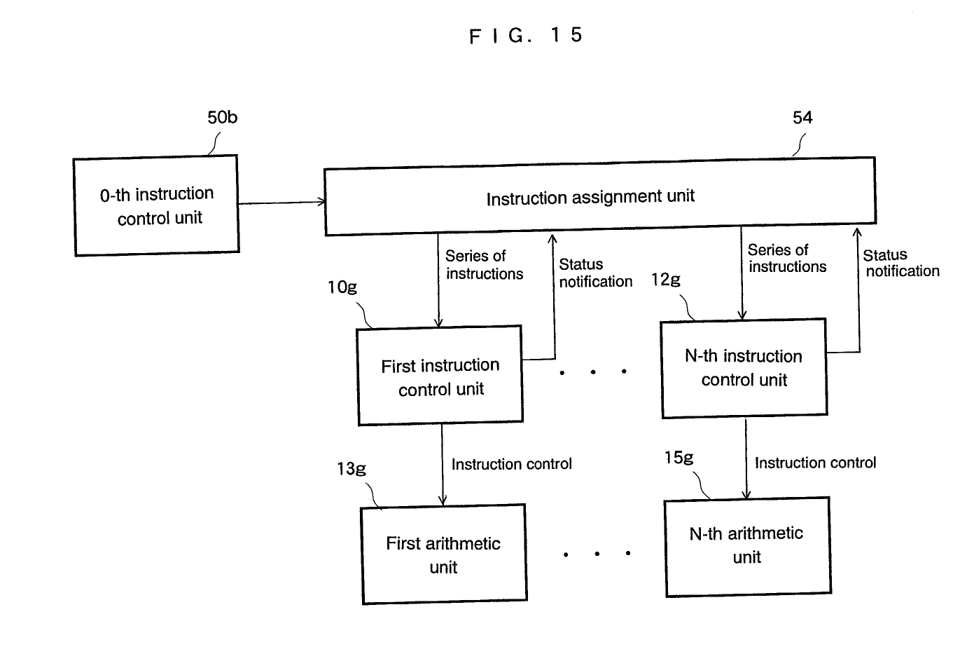

FIG. 15 is a block diagram showing an example of a processor comprising a primary instruction control unit (a 0-th instruction control unit 50b according to the present embodiment), a plurality of secondary instruction control units (the first instruction control unit log to the N-th instruction control unit 12g), a plurality of arithmetic units (the first arithmetic unit 13g to the N-th arithmetic unit 15g) corresponding to the secondary instruction control units, and an instruction assignment unit 54 for determining to which instruction control unit a series of instructions is to be assigned based on the instruction execution status of each secondary instruction control unit.

According to the present embodiment, each secondary instruction control unit notifies the instruction assignment unit 54 of an instruction execution state (that is, the driving state of an arithmetic unit). When the 0-th instruction control unit 50 issues a series of instructions, the instruction assignment unit 54 checks the instruction execution status from the first instruction control unit to the N-th instruction control unit, and issues a series of instructions to an arithmetic unit whose operation has stopped, or an arithmetic unit which can accept an interrupt. For example, a mechanism similar to the parallel instruction mechanism of a super-scalar processor can be used. When an instruction control unit receives the series of instructions, it drives an arithmetic unit using the series of instructions. Thus, according to the present embodiment, arithmetic units can be driven in parallel by assigning a series of instructions by the determination of hardware regardless of the information incorporated into a series of instructions in advance.

Embodiment 8

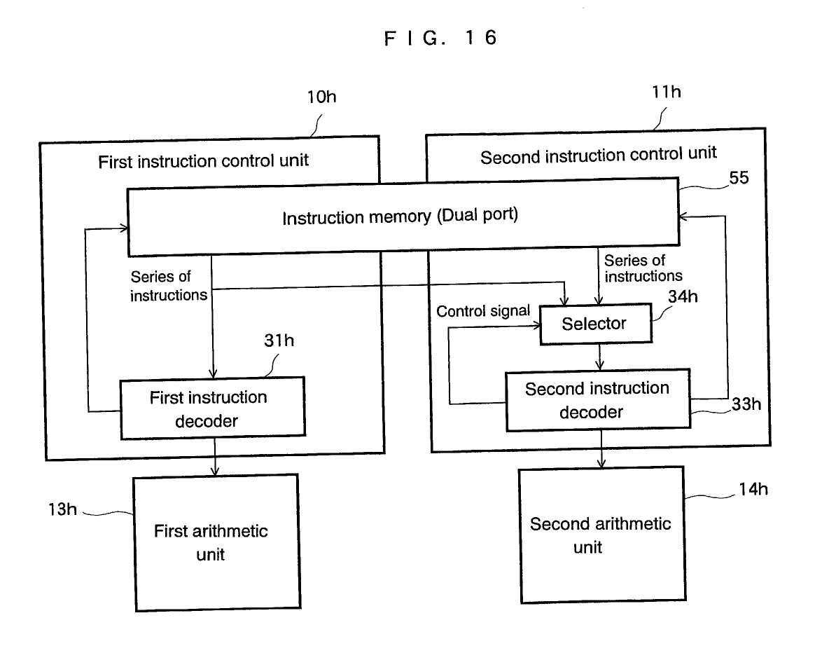

FIG. 16 is a block diagram showing an example of a processor comprising two arithmetic units and two instruction control units. Each instruction control unit has common instruction memory 55, and does not have its own instruction memory. The instruction memory 55 has two ports (dual port), and issues from each port a series of instructions to an instruction decoder of each instruction control unit.

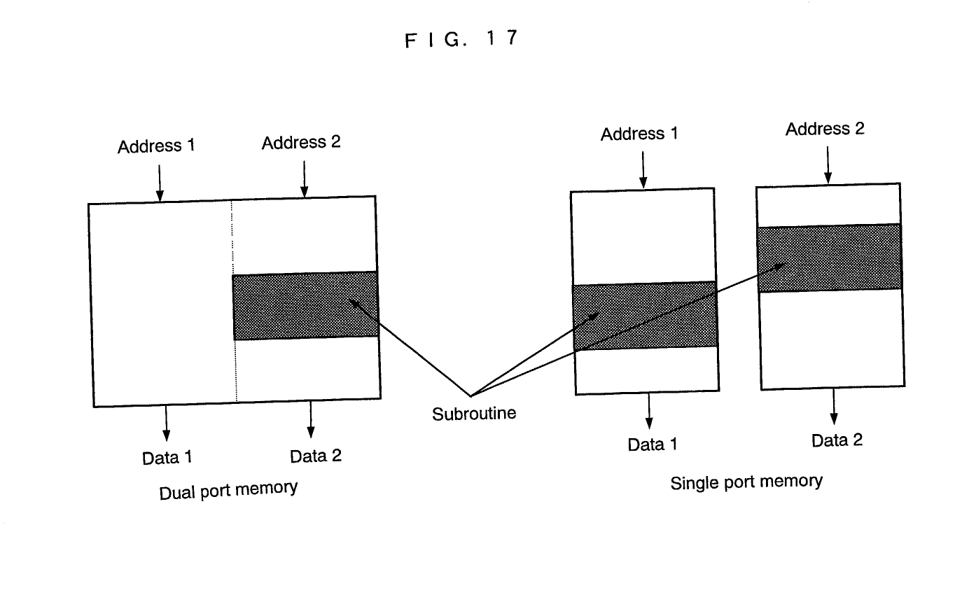

Thus, the configuration in which two instruction control units stores series of instructions in the same instruction memory 55 provides an advantage that when there is a subroutine for driving each arithmetic unit in a single program, it is not necessary to provide the subroutine for each instruction control unit. FIG. 17 shows an example of the configuration of the subroutine in the dual port memory and the single port memory when a program contains the above-mentioned subroutine.

When two instruction control units have respective single port memories, the subroutines which drive respective arithmetic units have to be provided in the respective instruction memories as shown on the right in FIG. 17. However, when there is common dual port memory, only one unit of memory is provided in the subroutine as shown on the left shown in FIG. 17, thereby easily managing a program, and reducing a necessary capacity.

Embodiment 9

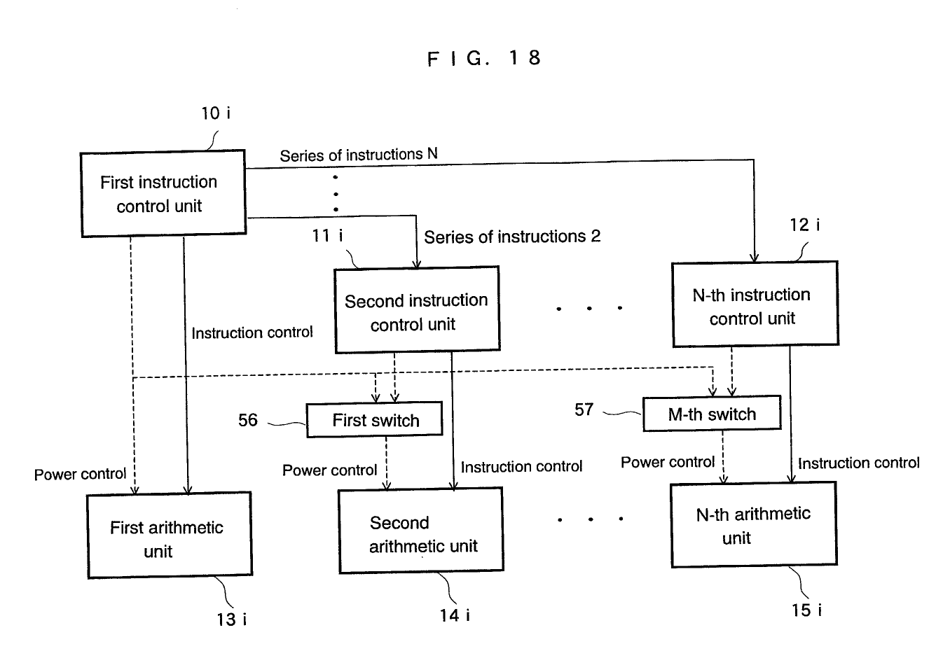

FIG. 18 is a block diagram showing an example of the configuration of the processor whose electric power can be individually controlled by each instruction control unit. There are respective switches between the instruction control units other than the first instruction control unit 10i and corresponding arithmetic units. The power supply can be controlled by turning ON/OFF the switch according to a control signal from each instruction control unit based on the drive status of each arithmetic unit,

Practically, for example, when the second arithmetic unit 14i independently executes an instruction, the second instruction control unit 11i corresponding to the second arithmetic unit 14i turns a first switch 56 on for power supply. When the execution is completed, the first switch 56 is turned off to stop the power supply. When all arithmetic units are synchronously driven by a series of instructions from the first instruction control unit 10i, the first instruction control unit 10i collectively controls the power supply.

Although various embodiments of the present invention have been described above, the present invention is not limited to the above-mentioned embodiments, but can be widely applied in the scope of the gist of the present invention.

As described above, since a processor according to the present invention is configured such that the process of operating a plurality of arithmetic units using a single series of instructions can be switched from/to the process of operating the arithmetic units using respective series of instructions depending on the contents of the process, the processes can be efficiently performed based on the feature (granularity) of a task. Also relating to the image processing with voice, etc., the synchronization can be gained without raising the clock frequency. Furthermore, an independent process not requiring the synchronization can also be efficiently performed. In addition, since a series of instructions can be processed with an interrupt accepted at an appropriate timing, a smaller apparatus can be realized. Furthermore, in addition to the switching process, collective or individual power control of a plurality of instruction control units depending on each process can reduce necessary power.

What is claimed is:

1. A processor control apparatus for controlling a plurality of arithmetic units, said processor control apparatus comprising a plurality of instruction control units for issuing a series of instructions to said plurality of arithmetic units, some of said instruction control units being operable to switch between a first execution process for driving said plurality of arithmetic units by means of a single series of instructions and a second execution process for driving said plurality of arithmetic units by means of a plurality of different series of instructions, respectively.

2. The processor control apparatus according to claim 1,
wherein said some instruction control units each perform a switching process for switching between said first execution process and said second execution process according to information which is contained in advance in a series of instructions.

3. The processor control apparatus according to claim 1,
wherein when an M-th one of said instruction control units issues a second series of instructions to an N-th one of said arithmetic units which is performing said second execution process based on a first series of instructions issued by an N-th one of said instruction control units different from said M-th instruction control unit, said M-th instruction control unit is set in a wait state until said N-th arithmetic unit completes said second execution process.

4. The processor control apparatus according to claim 1, further comprising a first storage element for holding a plurality of series of instructions,
wherein when an M-th one of said instruction control units issues a second series of instructions to an N-th one of said arithmetic units which is performing said second execution process based on a first series of instructions issued by an N-th one of said instruction control units different from said M-th instruction control unit, said second series of instructions from said M-th instruction control unit are stored in said first storage element, and
wherein said N-th arithmetic unit executes instructions which are stored in said first storage element based on information contained in said first series of instructions issued by said N-th instruction control unit.

5. The processor control apparatus according to claim 1, further comprising a second storage element which operates to hold, when one of said arithmetic units executing a series of instructions from one of said instruction control units is switched to execute a series of instructions from another instruction control unit, data generated by the series of instructions under execution by associating the data with that instruction control unit which is executing the series of instructions.

6. The processor control apparatus according to claim 1,
wherein it is determined, based on an instruction executing state of each arithmetic unit, one of said arithmetic units to which a new series of instructions is to be issued by one of said instruction control units, and
wherein said one instruction control unit is controlled based on the result of the determination so that the new series of instructions are directed to said one arithmetic unit thus determined.

7. The processor control apparatus according to claim 1,
wherein each of said series of instructions includes a VLIW type instruction.

8. The processor control apparatus according to claim 1,
wherein each of said series of instructions includes a series of time sharing instructions for serially driving a plurality of ones of said arithmetic units.

9. The processor control apparatus according to claim 1, further comprising power control elements for controlling power supply to said arithmetic units based on their instruction executing states.

10. A processor control apparatus comprising:
a plurality of instruction memories for storing a plurality of series of instructions to be executed by a plurality of arithmetic units;
an instruction decoder for decoding a series of instructions from said instruction memories, and outputting a decoded result to any of said plurality of arithmetic units; and
a selector for selectively switching between a plurality of series of instructions from said instruction memories to be decoded by said instruction decoder, and supplying a series of instructions thus selected to said instruction decoder.

11. The processor control apparatus according to claim 10,
wherein some of said plurality of series of instructions contain information about selective switching between said series of instructions to be performed by said selector, and
wherein said instruction decoder decodes said information contained in a series of instructions, and outputs a switching instruction to said selector.

12. The processor control apparatus according to claim 10,
wherein some of said plurality of series of instructions contain a synchronizing instruction for allowing a first predetermined one of said arithmetic units and a second predetermined arithmetic unit to synchronously perform processes, and
wherein when said synchronizing instruction is issued to said first predetermined arithmetic unit, said first predetermined arithmetic unit is set in a wait state, and an instruction decoder of said second predetermined arithmetic unit does not output a switching instruction to its associated selector if a process is being executed by said second predetermined arithmetic unit upon issuance of said synchronizing instruction, and does not release the wait state of said first predetermined arithmetic unit until said second predetermined arithmetic unit completes said process.

13. The processor control apparatus according to claim 10, further comprising:
an instruction queue for temporarily storing, at a stage prior to said selector, a series of instructions to be transmitted from a second one of said instruction memories different from a first one of said instruction memories which stores a series of instructions being executed by said first predetermined arithmetic unit; and
a determiner for determining, based on a series of instructions being executed, whether or not the process being performed by said first predetermined arithmetic unit can be interrupted, said determiner operating to output, if the process can be interrupted, an interrupt signal for interrupting the issuance of the series of instructions to said first instruction memory which is a source of the series of instructions being executed, and generate a switching instruction to said selector to switch to a series of instructions from said instruction queue.

14. The processor control apparatus according to claim 10,
wherein each of said series of instructions includes a VLIW type instruction.

15. The processor control apparatus according to claim 10,
wherein each of said series of instructions includes a series of time sharing instructions for serially driving a plurality of ones of said arithmetic units.

16. The processor control apparatus according to claim 10, further comprising power control elements for controlling power supply to said arithmetic units based on their instruction executing states.

17. A processor control apparatus comprising:
a single instruction memory for storing a plurality of series of instructions to be executed by a plurality of arithmetic units;
an instruction decoder for decoding a series of instructions from said instruction memory, and outputting a decoded result to any of said plurality of arithmetic units; and
a selector for selectively switching between a plurality of series of instructions from said instruction memory to be decoded by said instruction decoder, and supplying a series of instructions thus selected to said instruction decoder;
wherein said instruction memory has a plurality of ports for issuing said series of instructions to said respective instruction decoders.

18. A processor control apparatus for controlling a plurality of arithmetic units, said processor control apparatus comprising a plurality of instruction control units for instructing said arithmetic units to execute a series of instructions,
wherein each of said instruction control units includes:
an instruction memory for storing a plurality of series of instructions; and
an instruction decoder for decoding a series of instructions and supplying the decoded series of instructions to an associated one of said arithmetic units, and
wherein some of said instruction control units each have an instruction control selector for selectively switching between a first series of instructions from a first instruction memory of one of said instruction control units and a second series of instructions from a second instruction memory of another instruction control unit different from said one instruction control unit to output one of said first and second series of instructions thus selected to said instruction decoder,
wherein each of said arithmetic units includes:
a first register file and a second register file for storing data generated by said first and second series of instructions, respectively, which are supplied from said first and second instruction memories and decoded by an instruction decoder of an associated one of said instruction control units; and
an arithmetic unit selector for selectively switching between said data generated by said first and second series of instructions being executed and stored in said first and second register files, respectively, according to an instruction from said associated instruction decoder to supply a selected one of said first and second series of instructions to a calculator.

19. The processor control apparatus according to claim 18,
wherein each of said series of instructions includes a VLIW type instruction.

20. The processor control apparatus according to claim 18,
wherein each of said series of instructions includes a series of time sharing instructions for serially driving a plurality of ones of said arithmetic units.

21. The processor control apparatus according to claim 18, further comprising power control elements for controlling power supply to said arithmetic units based on their instruction executing states.

22. A processor control apparatus for controlling a plurality of arithmetic units, said processor control apparatus comprising a plurality of instruction control units for instructing said arithmetic units to execute a series of instructions,
wherein said instruction control units have a single instruction memory used in common for storing a plurality of series of instructions, and each includes an instruction decoder for decoding a series of instructions and supplying the decoded series of instructions to an associated one of said arithmetic units, and said single instruction memory has a plurality of ports for issuing said series of instructions to said respective instruction decoders,
wherein some of said instruction control units each having an instruction control selector for selectively switching between a first series of instructions and a second series of instructions both from said single instruction memory to output one of said first and second series of instructions thus selected to said instruction decoder,
wherein each of said arithmetic units includes:
a first register file and a second register file for storing data generated by said first and second series of instructions, respectively, which are supplied from said single instruction memory and decoded by an instruction decoder of an associated one of said instruction control units; and
an arithmetic unit selector for selectively switching between said data generated by said first and second series of instructions being executed and stored in said first and second register files, respectively, according to an instruction from said associated instruction decoder to supply a selected one of said first and second series of instructions to a calculator.

23. A processor comprising:
a plurality of arithmetic units; and
a plurality of instruction control units for issuing a series of instructions to drive said arithmetic units in a cotrolled manner;
wherein some of said instruction control units are operable to switch between a first execution process for driving said plurality of arithmetic units by means of a single series of instructions and a second execution process for driving said plurality of arithmetic units by means of a plurality of different series of instructions, respectively.

24. A processor comprising:
a plurality of arithmetic units;
a plurality of instruction memories for storing a plurality of series of instructions to be executed by said plurality of arithmetic units;
an instruction decoder for decoding a series of instructions from said instruction memories, and outputting a decoded result to any of said plurality of arithmetic units; and
a selector for selectively switching between a plurality of series of instructions from said instruction memories to be decoded by said instruction decoder, and supplying a series of instructions thus selected to said instruction decoder.

25. A processor comprising:
a plurality of arithmetic units;
a single instruction memory for storing a plurality of series of instructions to be executed by said plurality of arithmetic units;
an instruction decoder for decoding a series of instructions from said instruction memory, and outputting a decoded result to any of said plurality of arithmetic units; and
a selector for selectively switching between a plurality of series of instructions from said instruction memory to be decoded by said instruction decoder, and supplying a series of instructions thus selected to said instruction decoder;
wherein said instruction memory has a plurality of ports for issuing said series of instructions to said respective instruction decoders.

26. A processor comprising:
a plurality of arithmetic units;
a plurality of instruction control units for driving said arithmetic units in a controlled manner,
wherein each of said instruction control units includes:
an instruction memory for storing a plurality of series of instructions; and
an instruction decoder for decoding a series of instructions and supplying the decoded series of instructions to an associated one of said arithmetic units, and
wherein some of said instruction control units each have an instruction control selector for selectively switching between a first series of instructions from a first instruction memory of one of said instruction control units and a second series of instructions from a second instruction memory of another instruction control unit different from said one instruction control unit to output one of said first and second series of instructions thus selected to said instruction decoder,
wherein each of said arithmetic units includes:
a first register file and a second register file for storing data generated by said first and second series of instructions, respectively, which are supplied from said first and second instruction memories and decoded by an instruction decoder of an associated one of said instruction control units; and
an arithmetic unit selector for selectively switching between said data generated by said first and second series of instructions being executed and stored in said first and second register files, respectively, according to an instruction from said associated instruction decoder to supply a selected one of said first and second series of instructions to a calculator.

27. A processor comprising:
a plurality of arithmetic units;
a plurality of instruction control units for driving said arithmetic units in a controlled manner,
wherein said instruction control units have a single instruction memory used in common for storing a plurality of series of instructions, and each includes an instruction decoder for decoding a series of instructions and supplying the decoded series of instructions to an associated one of said arithmetic units, and said single instruction memory has a plurality of ports for issuing said series of instructions to said respective instruction decoders,
wherein some of said instruction control units each having an instruction control selector for selectively switching between a first series of instructions and a second series of instructions both from said single instruction memory to output one of said first and second series of instructions thus selected to said instruction decoder,
wherein each of said arithmetic units includes:
a first register file and a second register file for storing data generated by said first and second series of instructions, respectively, which are supplied from said single instruction memory and decoded by an instruction decoder of an associated one of said instruction control units; and
an arithmetic unit selector for selectively switching between said data generated by said first and second series of instructions being executed and stored in said first and second register files, respectively, according to an instruction from said associated instruction decoder to supply a selected one of said first and second series of instructions to a calculator.

28. A processor controlling method usable with a plurality of instruction control units for controlling a plurality of arithmetic units to execute a plurality of series of instructions, said method comprising the steps of:
prescribing, in advance in a series of instructions which is to be performed, synchronous execution in which a plurality of predetermined ones of said arithmetic units are synchronously driven by a single series of instructions, or independent execution in which the plurality of predetermined arithmetic units are independently driven by a plurality of respective series of instructions; and
switching between the predetermined arithmetic units for performing a series of instructions based on the contents of the prescription therein.
